(19) United States
(12) Patent Application Publication
(10) Pub. No.: US 2006/0089965 A1
(43) Pub. Date: Apr. 27, 2006

(54) Dynamic linkage of an application server and a Web server

(75) Inventors: Stephen M. Fontes, Fuquay-Varina, NC (US); Rengan Sundararaman, Cary, NC (US); Leigh A. Williamson, Austin, TX (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/973,121

(22) Filed: Oct. 26, 2004

(51) Int. Cl. G06F 15/16

(52) U.S. Cl. 709/203

(57) ABSTRACT

A method, system and apparatus for dynamically linking a content server to one or more application servers can include updating a routing configuration for the content server by automatically cataloging host application servers for an application serviced by the content server. Specifically, the updating step can include determining each host application server for portions of the application; and, adding each determined host application server to a list of application servers fronted by the content server. Moreover, the determining step can include determining each host application server for each target of each module of the application. Finally, the method further can include automatically cataloging host application server clusters for the application serviced by the content server.

### BACKGROUND OF THE INVENTION

1. Statement of the Technical Field

The present invention relates to an application distribution system and more particularly to the linkage of a content server to one or more application servers or a cluster of application servers in an application distribution system.

2. Description of the Related Art

Prior to the popularization of the Internet and the subsequent implementation of the World Wide Web (“the Web”), software publishers typically distributed computer applications via storage media such as a computer diskette or compact disc. Initially, such stand-alone computer applications included underlying program logic, data storage and, optionally, a user interface. Recently, given the popularization of the Internet and the Web, it is no longer reasonable to presume that computer applications are distributed exclusively via disk medium. Rather, in many cases, conventional computer programs are distributed electronically via the Internet. More importantly, however, in many cases computer applications are no longer distributed as stand-alone executable programs. Rather, many computer applications are distributed as browser based applications which can include a collection of hypermedia documents such as Web pages which can be viewed in hypermedia content browsers such as Web browsers.

In the case of a browser based application, users can interact with the underlying program logic not through a traditional GUI, but through a GUI provided by GUI elements embedded in a hypermedia document displayed in a content browser. Conventional markup can be visually presented through use of a content browser. Content browsers process display attributes embedded in markup to properly format content also contained within the markup. Notable variants of the content browser include the venerable Web browser, as well as the more recent extensible markup language (XML) browser. Regardless of the type of browser, all conventional markup processors are preconfigured to parse and interpret attribute tags embedded in markup.

While basic browser based applications serve the purpose of simplified computing needs, the content server/content browser arrangement alone cannot support more complex logic. Rather, to handle more complex computing tasks, advanced back-end logic can be integrated with the front end browser based application logic to provide a composite solution. Initially, the back-end logic included conventional programmatic logic configured to be accessed through a gateway medium such as the common gateway interface (CGI). An inability to scale the CGI architecture, however, gave rise more recently to the application server and the cluster of application servers.

In an application server architecture, a content server can be statically linked to an application server or to a cluster of application servers. Complex programmatic logic can reside in the application server. Requests to the content server which require service by one or more application components in the application server can be routed to the application server by way of the static linkage. Notably, the application server can manage the operation of the application components. Moreover, in a clustered arrangement access to the application components can be bolstered by load balancing and failover methodologies. In this way, complex programmatic logic can be accommodated without sacrificing scalability.

In a conventional application server arrangement, a content server routing can be used to forward requests from the content server to the application server. The routing information that can be used to associate the application server with the content server can be stored in a configuration file for the routing. In this regard, as one example, a routing configuration can be a configuration file read by a plug-in to a content server, such as a Web browser, proxy server or load balancing server.

Thus, the linkage between the content server and the application server can be static in nature. Yet, a pure topology based association can be brittle and rigid. Furthermore, the static topology based association cannot function when the topology definitions themselves become virtual in nature. Most importantly, with a topology based approach, manual intervention will be required to explicitly associate every content server with every application server in the computing environment. While manual intervention can suffice for small deployments, large scale deployments require substantial scalability and availability not afforded by the static topology approach.

### SUMMARY OF THE INVENTION

The present invention addresses the deficiencies of the art in respect to content server configuration for linkage to an application server and provides a novel and non-obvious method, system and apparatus for dynamically linking a content server to one or more application servers in an application distribution system. In this regard, an application distribution system configured for dynamic linkage between a content server and a plurality of application servers can include a content server, for instance a Web server; one or more application servers hosting modules of an application; routing configuration for the content server; and, routing configuration generation logic programmed to dynamically modify the routing configuration to link the content server to the application servers. The system also can include a cluster of application servers, wherein the routing configuration generation logic is further programmed to dynamically modify the routing configuration to link the content server to the cluster of application servers.

A method for dynamically linking a content server to a one or more application servers can include updating a routing configuration for the content server by automatically cataloging host application servers for an application serviced by the content server. Specifically, the updating step can include determining each host application server for portions of the application; and, adding each determined host application server to a list of application servers fronted by the content server. Moreover, the determining step can include determining each host application server for each target of each module of the application. Finally, the method further can include automatically cataloging host application server clusters for the application serviced by the content server.

Advantages of the present invention can include providing an administrator with the ability to install an application and identify any content server in the environment as the front-end. Consequently, the system can adjust the application request routing automatically by dynamically modifying the routing configuration. By comparison, in the fixed topology of the past, the administrator otherwise would be required to determine manually the location of each application server hosting a module in the application in order to ensure proper message routing between the content server and the application servers.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an application distribution system configured for dynamically linking one or more application servers or one or more clusters of application servers to a content server in accordance with the present invention; and,

FIG. 2 is a flow chart illustrating a process for dynamically linking one or more application servers or one or more clusters of application servers to a content server in the application distribution system of FIG. 1.

### DETAILED DESCRIPTION OF THE PREFERRED EMBODIMENTS

The present invention is a method, system and apparatus for dynamically linking one or more application servers or one or more clusters of application servers to a content server in an application distribution system. In accordance with the present invention, a content server can be configured with a dynamically modifiable routing configuration. Specifically, for a new application, the host application servers or application server clusters can be determined for the modules of the application in order to generate the routing configuration for the application. Accordingly, as the modules of the application change over time, so too will the routing configuration.

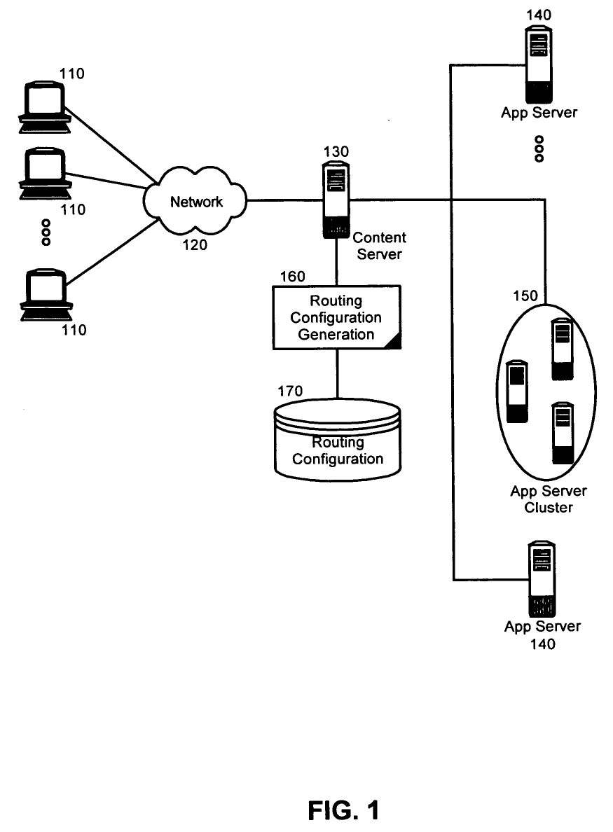

In more particular explanation, FIG. 1 is a schematic illustration of an application distribution system configured for dynamically linking one or more application servers or one or more clusters of application servers to a content server in accordance with the present invention. As shown in FIG. 1, the application distribution system can include a content server 130 configured for communicative coupling to one or more content consuming clients 110 over the computer communications network 120. The content server 130 can be configured to distribute content to the content consuming clients 110, for example as in the case of a basic Web server arrangement, though the content server 130 optionally can be a load balancing server or a proxy server. Generally, the content consuming clients 110 each can include a content browser (not shown) through which content served by the content server 130 can be rendered for display.

The content server 130 can support user interactions with an application. In this regard, the application can include one or more logical modules hosted within one or more application servers 140 coupled to the content server 130. Optionally, one or more of the logical modules of the application can be hosted within an application server cluster 150 so as to support a more advanced, scalable architecture incorporating load balancing and failover. To support the routing of requests to the modules of the application, a routing configuration 170 for the content server 130 can specify the individual locations for the modules of the application among the application servers 140 and, optionally, the application server clusters 150. In one aspect of the invention, the routing configuration can be a configuration file read by a content server plug-in.

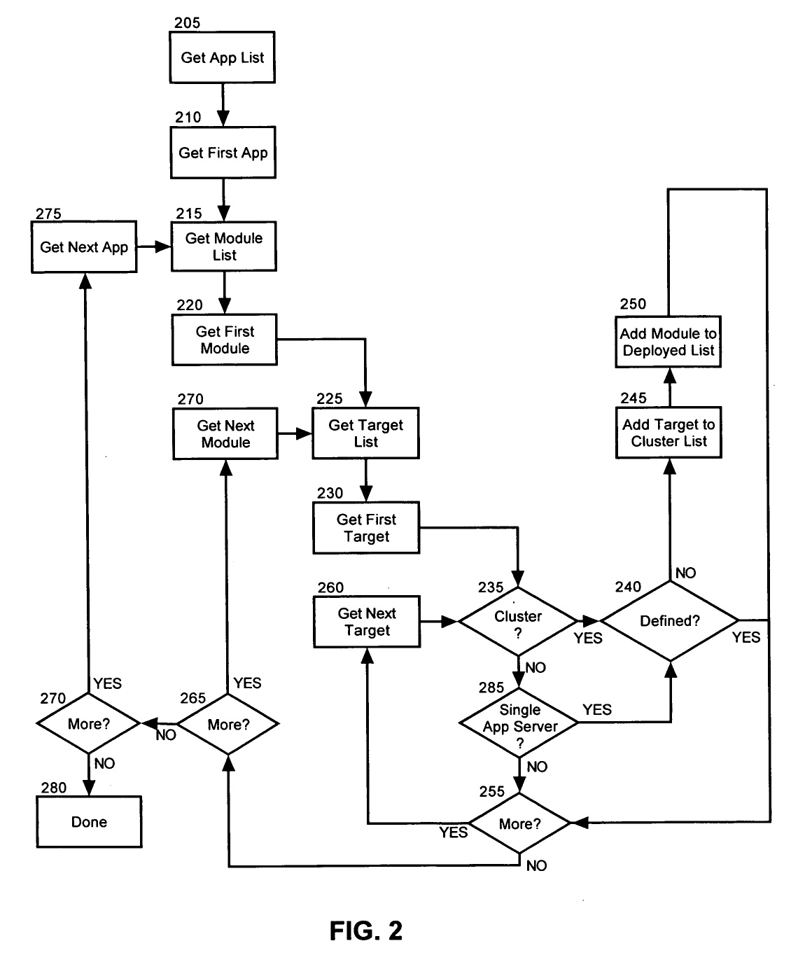

Significantly, a routing configuration generation process 160 can be coupled to the content server 130. The routing configuration generation process 160 can be programmed to dynamically manage the routing configuration 170. Specifically, as the applications supported by the application servers 140 change, the routing configuration generation process 160 can dynamically modify the routing configuration 170 to reflect new application server 140 and application server cluster 150 locations for different modules in the changed applications. In more specific illustration of the operation of the routing configuration generation process 160, FIG. 2 is a flow chart illustrating a process for dynamically linking one or more application servers or one or more clusters of application servers to a content server in an application distribution system.

Beginning in block 205, a list of all applications deployed on the content server can be retrieved. In block 210, a first application in the list can be retrieved and in block 215 a list of modules which have been deployed for the application also can be retrieved. In block 220, a first module in the list can be retrieved and in block 225 a list of targets for the deployed module can be retrieved. In block 230, a first target in the list can be retrieved. In decision block 235, if the target is determined to reside in a cluster of application servers and in decision block 240 if it is determined that the target has not yet been defined for the content server, in block 245 the target can be added to a list of application server clusters fronted by the content server. Also, in block 250, the module can be added to a list of modules which have been deployed for that cluster of application servers.

In contrast, if in decision block 235 the target is determined not to reside in a cluster of application servers, in decision block 285 it can be determined if the application server is a single application server, or whether the application server is part of a cluster of application servers. If, it is determined that the application server is a single application server, the process can proceed to block 240. Otherwise, if it is determined that the application server is part of a cluster of application servers, the process can proceed to block 255.

If in decision block 255 additional targets remain to be processed in the list of targets, in block 260 a next target in the list can be retrieved and the process can repeat through decision block 235. Otherwise, if in decision block 265 additional modules remain to be processed in the list of modules, in block 270 a next module in the list can be retrieved and the process can repeat through decision block 225. Otherwise, if in decision block 270 additional applications remain to be processed in the list of applications, in block 275 a next application in the list can be retrieved and the process can repeat through decision block 215. Otherwise, the process can end in block 280.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. An application distribution system configured for dynamic linkage between a content server and a plurality of application servers, the system comprising:
a content server;
a plurality of application servers hosting modules of an application;
a routing configuration for said content server; and,
routing configuration generation logic programmed to dynamically modify said routing configuration to link said content server to said application servers.

2. The system of claim 1, further comprising a cluster of application servers, wherein said routing configuration generation logic is further programmed to dynamically modify said routing configuration to link said content server to said cluster of application servers.

3. The system of claim 1, wherein said content server is a Web server.

4. The system of claim 1, wherein said content server is a proxy server.

5. The system of claim 1, wherein said content server is a load balancing server.

6. The system of claim 1, wherein said routing configuration comprises a configuration file read by a content server plug-in.

7. A method for dynamically linking a content server to a plurality of application servers, the method comprising the step of updating a routing configuration for the content server by automatically cataloging host application servers for an application serviced by the content server.

8. The method of claim 7, wherein said updating step comprises the steps of:
determining each host application server for portions of said application; and,
adding each said determined host application server to a list of application servers fronted by the content server.

9. The method of claim 7, where said updating step comprises the step of updating a configuration file read by a plug-in to the content server by automatically cataloging in said configuration file host application servers for an application serviced by the content server.

10. The method of claim 8, wherein said determining step comprises the step of determining each host application server for each target of each module of said application.

11. The method of claim 7, further comprising the step of automatically cataloging host application server clusters for said application serviced by the content server.

12. A machine readable storage having stored thereon a computer program for dynamically linking a content server to a plurality of application servers, the computer program comprising a routine set of instructions which when executed by a machine causes the machine to perform the step of updating a routing configuration for the content server by automatically cataloging host application servers for an application serviced by the content server.

13. The machine readable storage of claim 12, wherein said updating step comprises the steps of:
determining each host application server for portions of said application; and,
adding each said determined host application server to a list of application servers fronted by the content server.

14. The machine readable storage of claim 12, where said updating step comprises the step of updating a configuration file read by a plug-in to the content server by automatically cataloging in said configuration file host application servers for an application serviced by the content server.

15. The machine readable storage of claim 13, wherein said determining step comprises the step of determining each host application server for each target of each module of said application.

16. The machine readable storage of claim 12, further comprising the step of automatically cataloging host application server clusters for said application serviced by the content server.
